(19) United States
(12) Patent Application Publication
(10) Pub. No.: US 2006/0085304 A1
(43) Pub. Date: Apr. 20, 2006

(54) Corporate business tax web site

(76) Inventors: Michael Carlos Buarque De Macedo, Bethesda, MD (US); Alessandra Monteiro Buarque De Macedo, Bethesda, MD (US)

Correspondence Address: MICHAEL C. BUARQUE DE MACEDO, 7001 LOCH LOMOND DRIVE, BETHESDA, MD, 20817, US

(21) Appl. No.: 10/937,360

(22) Filed: Sep. 10, 2004

(51) Int. Cl. G06F 17/22

(52) U.S. Cl. 705/31

(57) ABSTRACT

A Corporate Business Income tax web site where a user enters the tax information into a web site using a web browser; the web site calculates the tax due or downloads mobile code and the mobile calculates the tax due; the corporate tax data is transferred to the taxing agency; an acknowledgment is received back from the taxing agency; the information in the acknowledgment is sent to the user. Also, a web site where the user who E-Files the tax return is verified using a digital ID.

### CROSS-REFERENCE TO RELATED APPLICATIONS

A peer-to-peer database connector for tax and other information patent application Ser. No. 10/856,759 filed on JUN. 1, 2004.

### STATEMENT REGARDING FEDERALLY SPONSORED RESEARCH OF DEVELOPMENT

Not applicable

### REFERENCES TO SEQUENCE LISTING, A TABLE OR A COMPUTER PROGRAM LISTING COMPACT DISK

Not applicable

### BACKROUND OF THE INVENTION

The present invention relates to allow a user to prepare and E-File a Corporate Business Income tax return on the Web using a web browser.

### DESCRIPTION OF THE PRIOR ART

The following patent is prior art:

Patent application number 20040002906, a “Tax transaction system” did not provide for preparing corporate income tax returns.

Mobile code is code that can travel over the internet, intranet or other network from one computer to another and execute. An example of this is java applets, Microsoft .NET J# Browser controls, Javascript, Microsoft Active-X controls and/or Microsoft .NET WinForms. This allows more of the processing power of greater number of computers to solve problems faster. This is particularly important during peak load periods when many users are using the website at the same time. Also, this allows for a richer user interface with more advanced features and error notification.

E-File is the process of sending tax information electronically to a taxing authority instead of sending printed forms.

HTML is Hyper Text Markup Language is a method of presenting information to a user as a web page in a web Browser.

Web Browser is a software application used to locate and display web pages.

A web page is a document located on the world wide web. The web page uses HTML to describe to the web browser how to display the web page.

A web site is a collection of web pages that allow a user to view data and/or enter information.

Corporate Business Income tax is the tax due from corporation based on income earned due to a taxing agency.

Tax information is the information that taxpayer must provide to a taxing agency to determine and access a tax.

A taxing agency is a local, state or federal government entity that assesses and collects taxes from businesses or individuals.

ASP is Microsoft's Active Server Pages, a specification for a dynamically created Web page. When a browser requests an ASP request, the Web server generates a page with HTML code and sends it back to the browser.

JSP, is SUN's Java Server Pages, a specification for a dynamically created Web page using JAVA. When a browser requests a JSP request, the Web server generates a page with HTML code and sends it back to the browser.

J2EE, Short for Java 2 Platform Enterprise Edition. J2EE is a platform-independent, Java-centric environment from Sun for developing, building and deploying Web-based enterprise applications online. The J2EE platform consists of a set of services, APIs, and protocols that provide the functionality for developing multitiered, Web-based applications.

JAVA is a programming language created by and specified by the Java Language Specification published by SUN Microsystems. Java is designed to run in any operating system, such as Microsoft Windows, MacOS, Unix, Linux, and Solaris.

JAVASCRIPT is Netscape's cross-platform, object-based scripting language. JAVASCRIPT is not related to JAVA in any way except the name of the computer language.

Microsoft .NET, Microsoft .NET is software that connects information, people, systems, and devices. It spans clients, servers, and developer tools, and consists of (a) The .NET Framework 1.1, used for building and running all kinds of software, including Web-based applications, smart client applications, and XML Web services—components that facilitate integration by sharing data and functionality over a network through standard, platform-independent protocols such as XML (Extensible Markup Language), SOAP, and HTTP. (b) Developer tools, such as Microsoft Visual Studio® .NET 2003 which provides an integrated development environment (IDE) for maximizing developer productivity with the .NET Framework. (c) A set of servers, including Microsoft Windows® Server 2003, Microsoft SQL Server™, and Microsoft BizTalk® Server, that integrates, runs, operates, and manages Web services and Web-based applications. (d) Client software, such as Windows XP, Windows CE, and Microsoft Office XP, that helps developers deliver a deep and compelling user experience across a family of devices and existing products.

CGI, Common Gateway Interface, a specification for transferring information between a World Wide Web server and a CGI program. A CGI program is any program designed to accept and return data that conforms to the CGI specification.

Tax Exchange Format is an industry standard format published for the exchange of tax information between accounting systems, tax software and financial institutions.

In its most simple form, a flat-file database is nothing more than a single, large table (e.g., a spreadsheet). A flat file contains only one record structure; there are no links between separate records. Access to data is done in a sequential manner; random access is not supported. Access times are slow because the entire file must be scanned to locate the desired data. Access times can be improved if the data is sorted but this introduces the potential for error (e.g., one or more records may be misfiled). Other problems with a flat-file database include 1) data redundancy; 2) data maintenance; and 3) data integrity. Flat file data structures are only viable for small data processing requirements.

For the purpose of this patent application the use of IRS terms such as the words: income, deductions, expenses, assets, liabilities, shareholders' equity etc. are as defined by the IRS for the given tax form(s) discussed below.

Taxpayers are required to fill in complex tax forms and pay taxes to national and state taxing agencies such as the United States Internal Revenue Service (IRS). The tax forms can be very complex from 1 page to 250,000 pages when printed out. Software has been developed to allow users to complete these tax returns by many companies.

Various tax web sites allow users to prepare e-file and pay Individual Income taxes. The current web sites allow users with a web browser to connect to a web server over the internet. There users can then answer a series of questions on the web site. The tax return is then prepared and printed for the user. We had prepared the first such web site in Oct. 15, 1996. Now, there are many such web sites.

I had written in January 2000 the first and only business income tax web site for Partnership tax returns. This web site solved many of the problems of preparing business tax returns. But it still could not support corporate income tax forms due to the complexity and size of the corporate tax return.

Many other companies by February 2004 had written software that could be installed on a computer to allow users to prepare and E-File corporate tax returns.

The object of the invention is to develop a web site to allow users to prepare, print and E-File corporate tax returns of varying sizes from 1 page to 250,000 pages or more. On Feb. 23, 2004, at 8:01 AM, we were the first ones to successfully make an electronic transmission of a 1120 tax return, prepared on the Internet.

A further object of the invention is to allow users to import and export data.

A further object of the invention is to develop the web site using mobile codes such as Microsoft Net, Active X, Java, or Java Script, for a rich user interface and increased scalability.

A further object of the invention is to allow users to make payments and receive refunds when the corporate tax return is E-Filed.

A further object of the invention is to allow users to receive acknowledgments from the taxing authority after the E-File is sent that includes acceptance, rejection and error messages.

A further object of the invention is to allow users to pay for the tax return to be E-Filed and pay for a batch of tax returns to be E-Filed.

### SUMMARY OF THE INVENTION

This summary of the invention section is intended to introduce the reader to aspects of the invention and is not a complete description of the invention. Particular aspects of the invention are pointed out in other sections herein below and the invention is set forth in the appended claims, which alone demarcate its scope.

A Corporate Business Income tax web site where a user enters the tax information into a web site using a web browser; the web site calculates the tax due; the corporate tax data is transferred to the taxing agency; an acknowledgment is received back from the taxing agency; the information in the acknowledgment is sent to the user.

### BRIEF DESCRIPTION OF THE DRAWINGS

FIG. 1 is an embodiment of the invention web page where the user can select and manage tax returns.

FIG. 2 is an embodiment of the invention web page where the user can enter income information for an IRS Form 1120 Corporate income tax return.

FIG. 3 is an embodiment of the invention web page where the user can enter deductions information for an IRS Form 1120 Corporate income tax return.

FIG. 4 is an embodiment of the invention web page where the user can enter Asset information for an IRS Form 1120 Corporate income tax return.

FIG. 5 is an embodiment of the invention web page where the user can enter Liabilities and Shareholder's Equity for an IRS Form 1120 Corporate income tax return.

FIG. 6 is an embodiment of the invention of a printout from a web page of a IRS Form 1120 Corporate Income tax return.

FIG. 7 is an embodiment of the invention web page where the user can enter income information for an IRS Form 1120S S Corporation income tax return.

FIG. 8 is an embodiment of the invention web page where the user can enter deduction information for an IRS Form 1120S S Corporation income tax return.

FIG. 9 is an embodiment of the invention web page where the user can enter Asset information for an IRS Form 1120S S Corporation income tax return.

FIG. 10 is an embodiment of the invention web page where the user can enter Liabilities and Shareholders' equity for an IRS Form 1120S S Corporation income tax return.

FIG. 11 is an embodiment of the invention web page where the user can view a list of all of the web pages in an IRS Form 1120S S Corporation income tax return.

FIG. 12 is an embodiment of the invention web page where the user can view a summary of tax information for an IRS Form 1120 Corporation income tax return.

FIG. 13 is an embodiment of the invention web page where the user can view error messages from the IRS about an IRS Form 1120 Corporation income tax return.

FIG. 14 is an embodiment of the invention web page where the user can pay for a single tax return to be printed or EFiled.

FIG. 15 is an embodiment of the invention web page where the user can pay for multiple tax returns to be printed or EFiled.

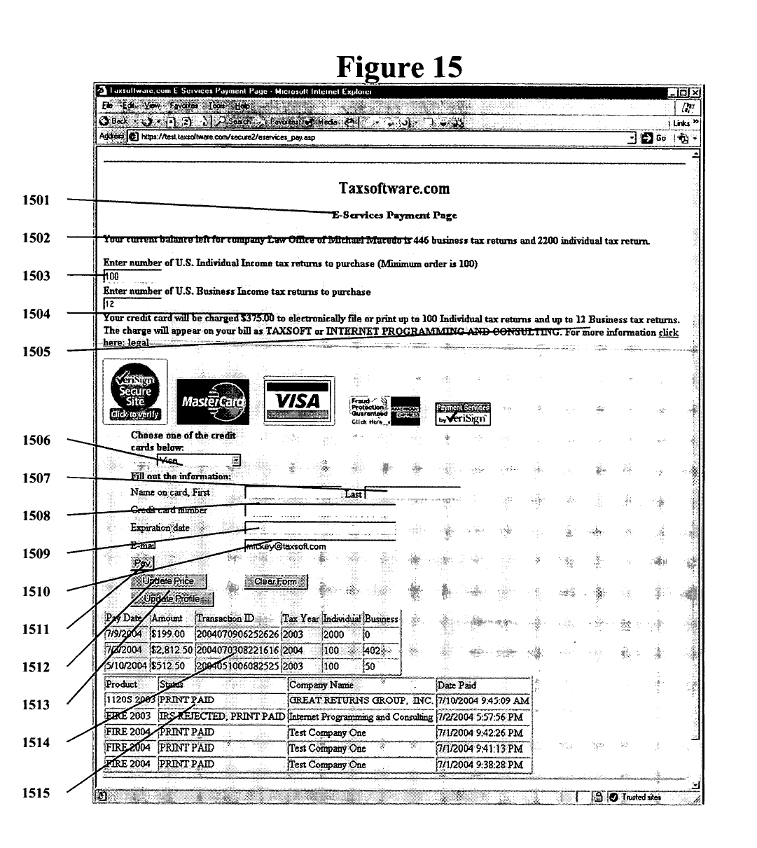

FIG. 16 is an embodiment of the invention web page where the user can enter Schedule K distribution information for a Form 1120S S Corporation income tax return.

FIG. 17 is an embodiment of the invention web page where the user can enter the names of shareholders for an S Corporation income tax return.

FIG. 18 is an embodiment of the invention where the web page allows the user to import or export the shareholder information to a spreadsheet.

### DETAILED DESCRIPTION OF THE INVENTION

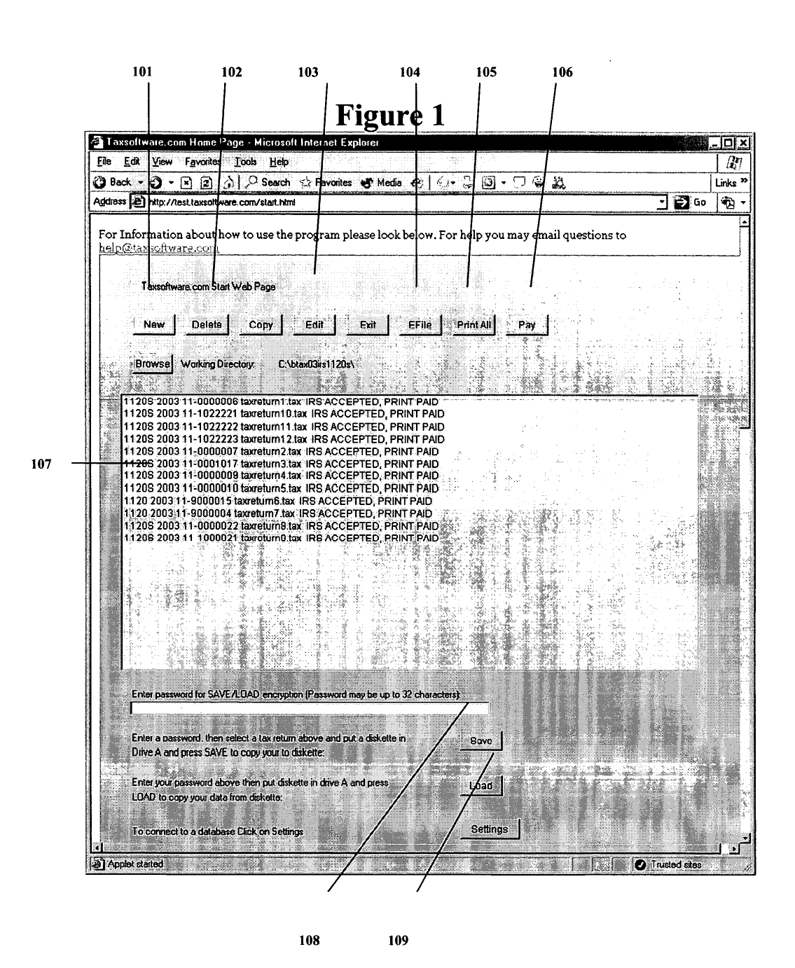

In FIG. 1 the user is presented with a list of previously prepared tax returns (107). In the list if the IRS has already accepted the tax return this is displayed in the list. The user can either start a new tax return (101) or select and existing tax return. After selecting an existing tax return the user can delete (102) the tax return, or edit (103) the tax return or E-File (104) the tax return or print the tax return (105), pay (106) for the tax return, or save (108) the tax return to removable media or load (109) a tax return from removable media.

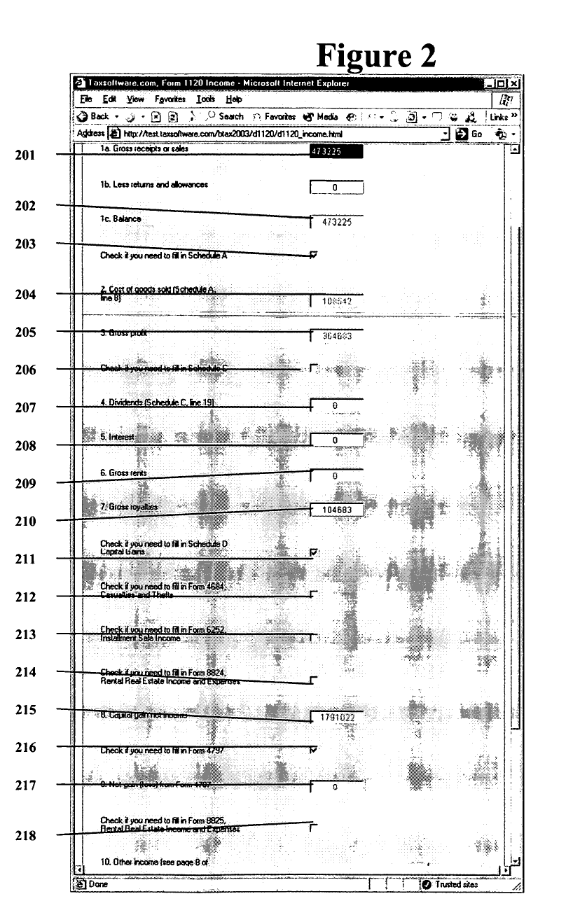

When a user edits an IRS Form 1120 Corporate income tax return a web page in FIG. 2 is used to input the income information. The user can enter the gross receipts or sales (201 and 202), select a cost of goods schedule (203). After the cost of goods schedule is entered the web site calculates enters the cost of goods (204). The web site then calculates the gross profit (205). The user can check the schedule C check box to enter dividends if any were received (206). The total from the dividends schedule is then calculated (207). The user can then enter the interest income (208). The user can check the Form 8825 for rental real estate income and expenses (218). If the user checks this box then the gross rents can be calculated (209). The user can then enter the gross royalties (210). If the user needs to enter a capital gain Schedule D (211), Form 4684 casualties and thefts (212), Form 6252 installment sale income (213) and Form 8824 (214) can be selected. The results from these forms can be calculated by the web site entered as the capital gain net income (215). Finally if Form 4797 (216) is selected the results from the form can be entered as net gain (loss) from Form 4797 (217) by the web site.

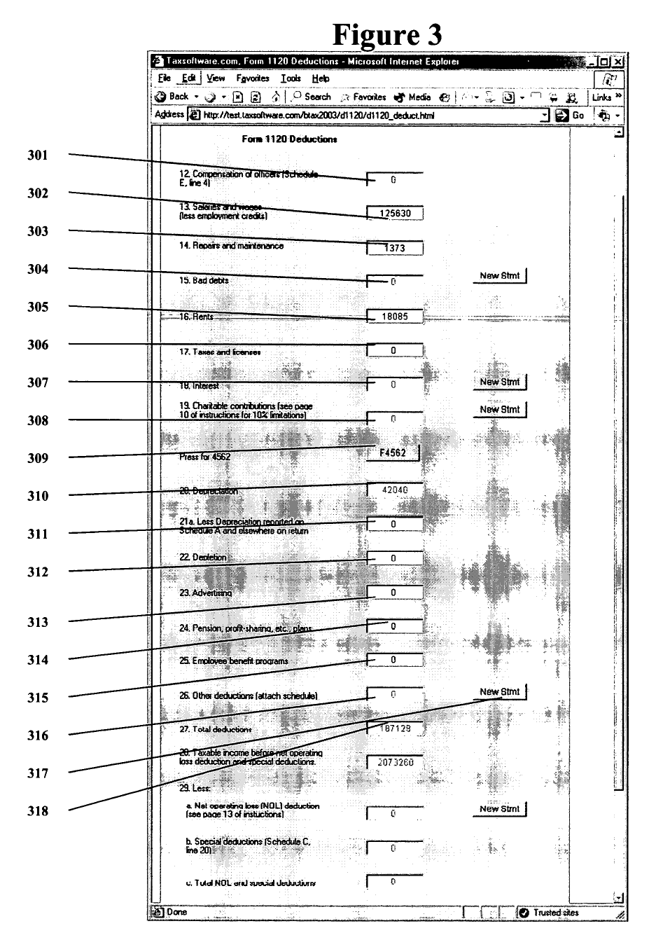

On the Form 1120 deductions web page in FIG. 3 the user can enter all of the deductions. The compensation of officers (301) is calculated from Schedule E. Then the user can enter salaries and wages (302) and repairs and maintenance 303, bad debts (304), rents (305), taxes and licenses (306), interest (307), and charitable contributions (308). If the user has any depreciable assets the user can press 4562 and fill in form 4562. The total of depreciation deductions is then calculated and the result is entered on 310. The user can then enter depreciation reported on Schedule A and elsewhere on the return (311), depletion (312), advertising (313), pension, profit-sharing (314), and employee benefit programs (315). The itemized other deductions can be entered by pressing the New Stmt (317) button and listing all of the deductions. The total of other deductions is then calculated (316). The web site then totals all of the deductions (318) and calculates the taxable income.

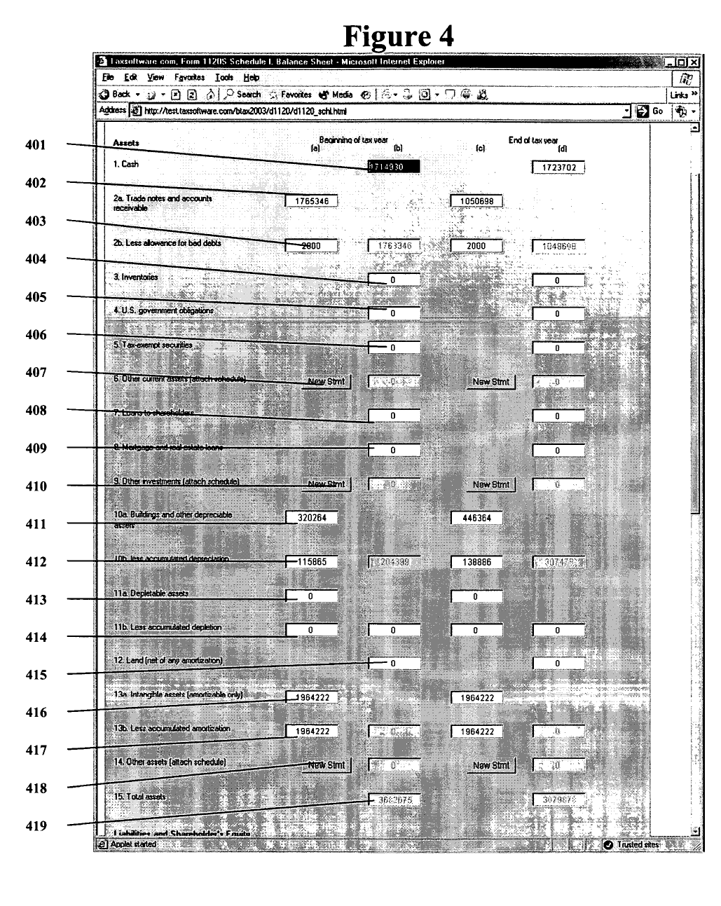

The user can then enter all of the assets for the corporation on the web page shown in FIG. 4. For each type of asset the user can enter a beginning of the year and end of year balance for the asset. The user enters the cash (401), trade notes and receivables (402), less allowance for bad debt (403), inventories (404), U.S. government obligations (405), and tax-exempt securities (406). The user can then itemize the other current assets (407) and the total is calculated. Next the user enters the loans to shareholders (408), mortgage and real estate loans (409). An itemized list of other investments (410) can be entered and the total is calculated. Then the user enters buildings and other depreciable assets (411), less accumulated depreciation (412), depletable assets (413), less accumulated depletion (414), land net of any amortization (415), intangible assets (416), and less accumulated amortization (417). The list of other assets can be attached by pressing the New Stmt button (418) and the total is calculated. Then the web site calculates the total assets (419).

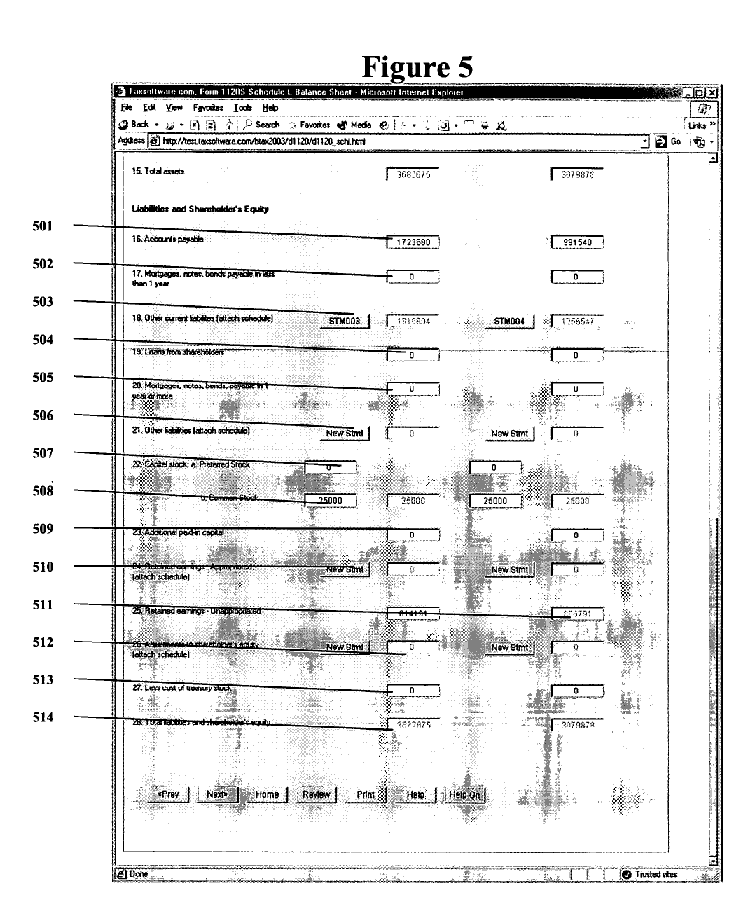

In FIG. 5, after entering assets the user can enter Liabilities and Shareholders' equity. For each entry on FIG. 5 the user can enter the beginning and end of year amounts. First the user enters accounts payable (501) and mortgages, notes, and bonds payable in less than 1 year (502). Then an itemized list of other current liabilities (503) can be entered and calculated. Next, loans from shareholders (504) and mortgages, notes, bonds payable in 1 year or more (505) are entered. An itemized schedule of other liabilities (506) can be entered. Then the Preferred Stock (507), common stock (508) and additional paid-in capital (509) amounts are entered. The appropriated retained earnings (510) can be itemized and calculated. The unappropriated retained earnings (511) are then calculated. If the user wants to change any calculation at any time the user can click on the number to be changed and type a new number. This override (511) will then block the calculation and change the box to a blue border. A schedule of adjustments to shareholders' equity is entered (512) and calculated, less the cost of treasury stock (513). Finally, the web site calculates a total liabilities and shareholders' equity (514).

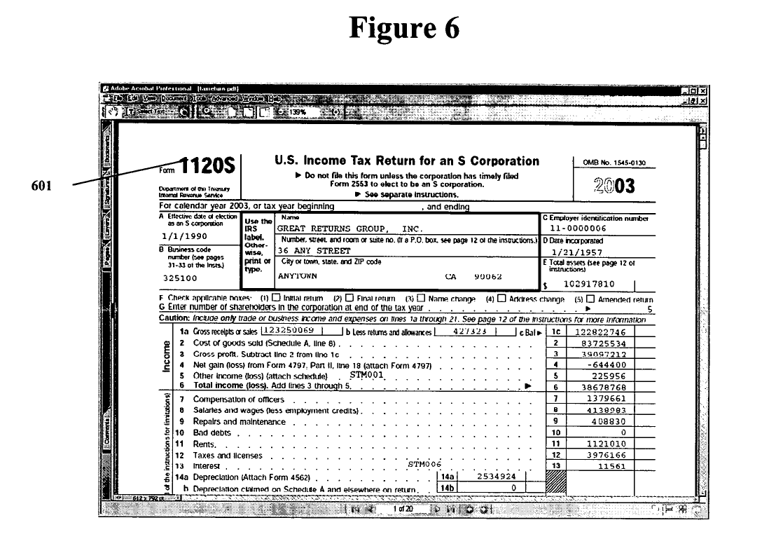

At any time on the web site the user can press the PRINT button and get a printed out copy of the filled in tax return. FIG. 6 shows how an IRS Form 1120S would print from the web site.

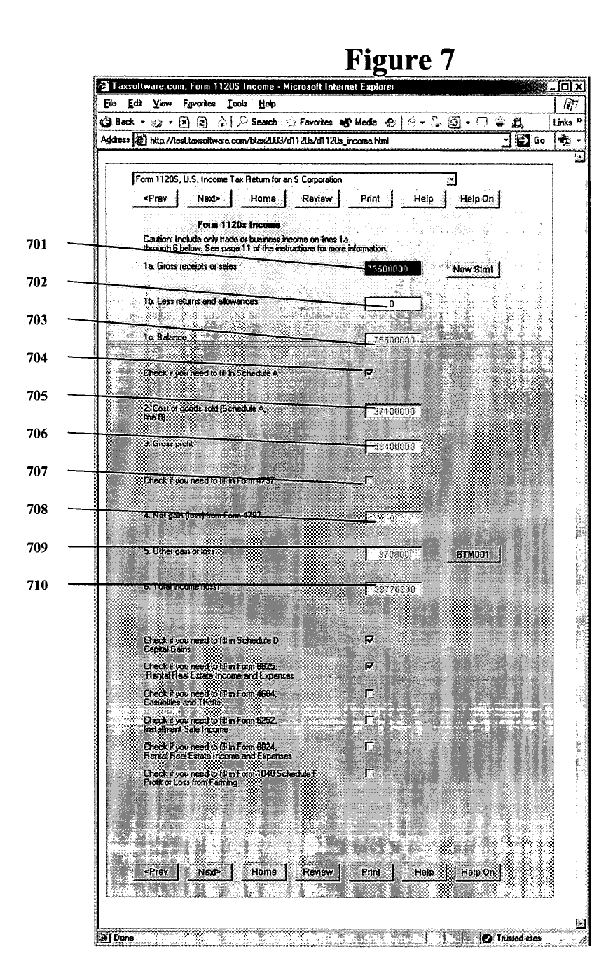

FIG. 7 is a web page where the user enters the income information for a Form 1120S S Corporation income tax return. First the user enters the gross receipts or sales (701) less returns and allowances (702). The web site calculates the balance (703). If the user has any goods purchased on Schedule A, the Cost of goods schedule box is checked. After the user fills in the Schedule A the total is calculated and transferred to cost of goods sold (705). The gross profit is calculated (706). If the user has Form 4797 capital gains (707) the user can enter the data and the web site will calculate and transfer the net gain or (loss) from Form 4797 (708). Other gains or losses (709) can be itemized and totaled. The total income (loss) is calculated 710.

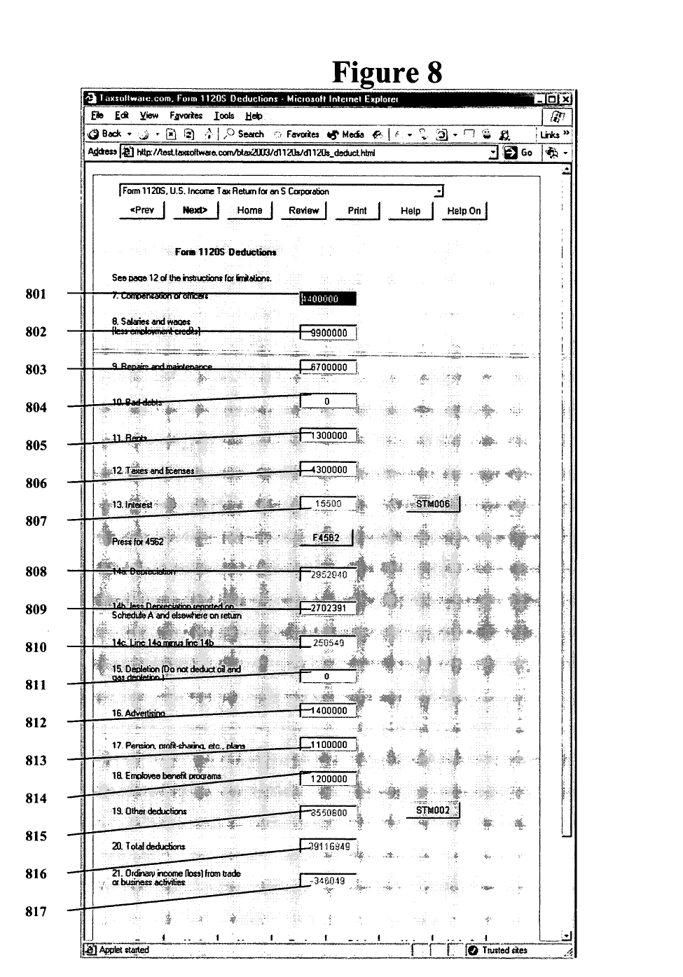

The Form 1120S user can enter the deductions on the next web page show in FIG. 8. The user can enter the compensation of officers (801), salaries and wages (less employment credits) (802), repairs and maintenance (803), bad debts (804), rents (805), taxes and licenses (806). Next the users can itemize the interest expenses and the total is calculated (807). The user can enter the depreciation information on Form 4562. The results can be calculated and transferred (808). The user can enter the amount of depreciation reported on Schedule A and elsewhere on the return (809). The net depreciation is calculated by the web site (810). The user can then enter depletion (811), advertising expense (812), pension and profit sharing plans (813), employee benefit programs (814). The itemized other deductions can be entered and the total is calculated and entered on 815. Then the total deductions are calculated by the web site (816). The net ordinary income is calculated onto 817.

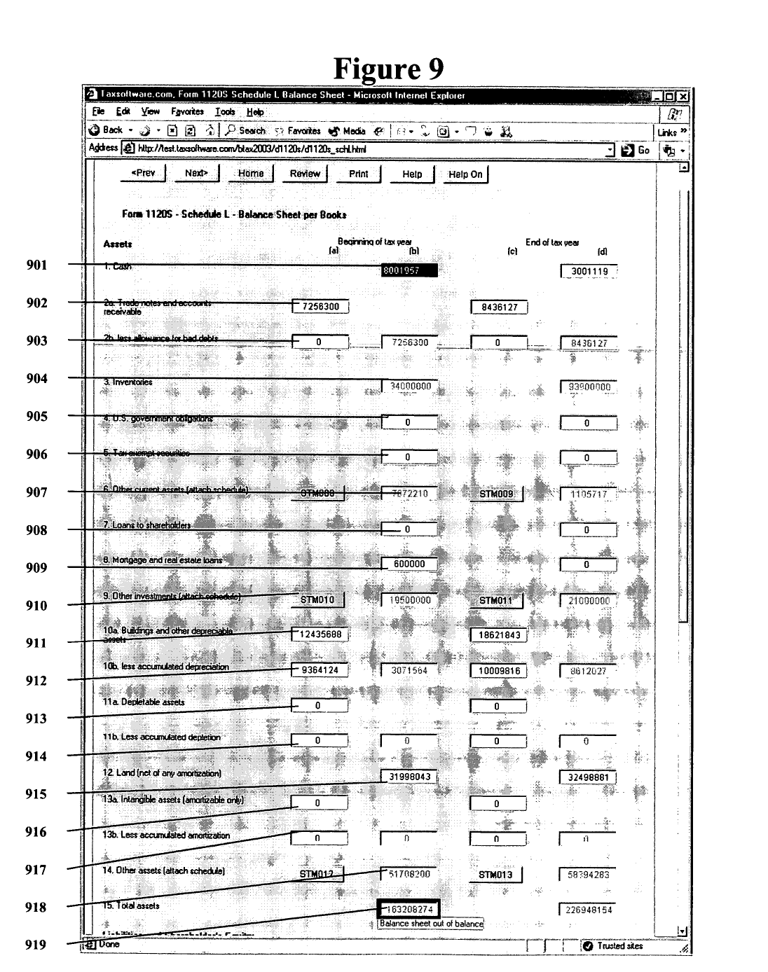

The user can then enter the assets for the Form 1120S on the web page shown on FIG. 9. The user enters the balances for each asset at the beginning of the year and the end of the year. The user enters the cash (901), trade notes and account receivables (902), less allowance for bad debts (903). The web site than transfers the inventories (904) from the Schedule A. The user can then enter the U.S. government obligations (905) and tax exempt securities (906). A statement of other assets (907) can be attached and totaled. The loans to shareholders (908) and mortgage and real estate loans (909) are entered. A statement of other investments is entered and totaled (910). The user than enters the buildings and other depreciable assets (911), less accumulated depreciation (912), depletable assets (913), less accumulated depletion (914), Land (net of any amortization) (915), intangible assets, and less accumulated amortization (916). The state of other assets can be entered and totaled (917). The total assets is then calculated (918). If there is an error that a given number does not match another number or is out of range for a given answer an error message is displayed on the input box (919).

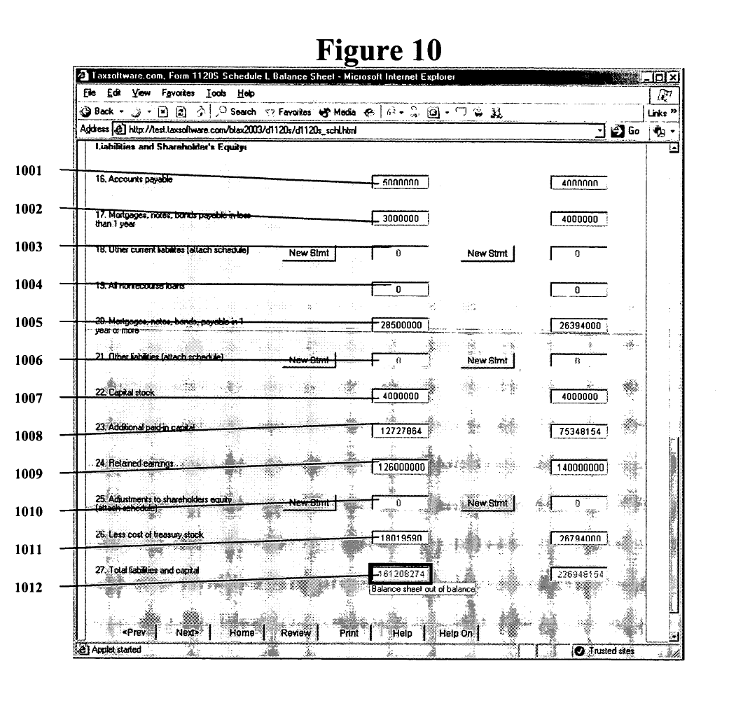

The next web page shown in FIG. 10 is the Liabilities and Shareholders' Equity. The user can enter the account payable (1001), and Mortgages, notes, bonds payable in less than 1 year (1002). A schedule of other current liabilities can be entered by the user and totaled by the website (1003). The user can then enter the non-recourse loans (1004) and mortgages, notes, bonds payable in 1 year or more (1005). A schedule of other liabilities can be entered and totaled (1006). The user can then enter the capital stock (1007), additional paid-in capital (1008) and retained earnings (1009). A schedule of adjustments to shareholders equity can be entered and totaled by the website (1010). Then the user can enter the less cost of treasury stock amount (1011). The web site then calculates the total liabilities and capital (1012). If the assets do not equal the total liabilities and capital an error message can be displayed (1012).

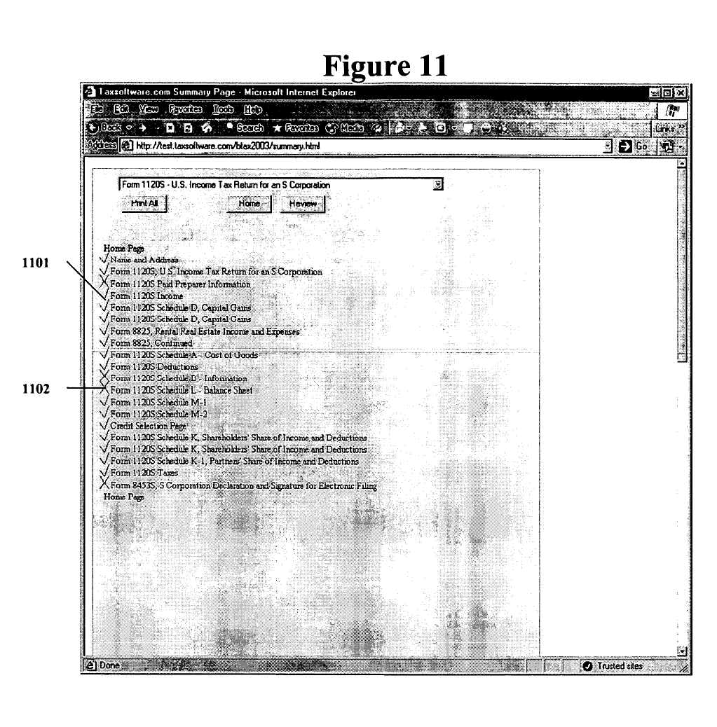

If the user clicks on the REVIEW button from any web page the user will get a list of web pages in the current tax return (FIG. 11). Then the user can click on any web page (1101 and 1102) to go directly to that web page instead of entering the data in order. If a web page has an error on it the web page can be displayed with a red x mark. If the web page has no errors it can be shown with a green check mark.

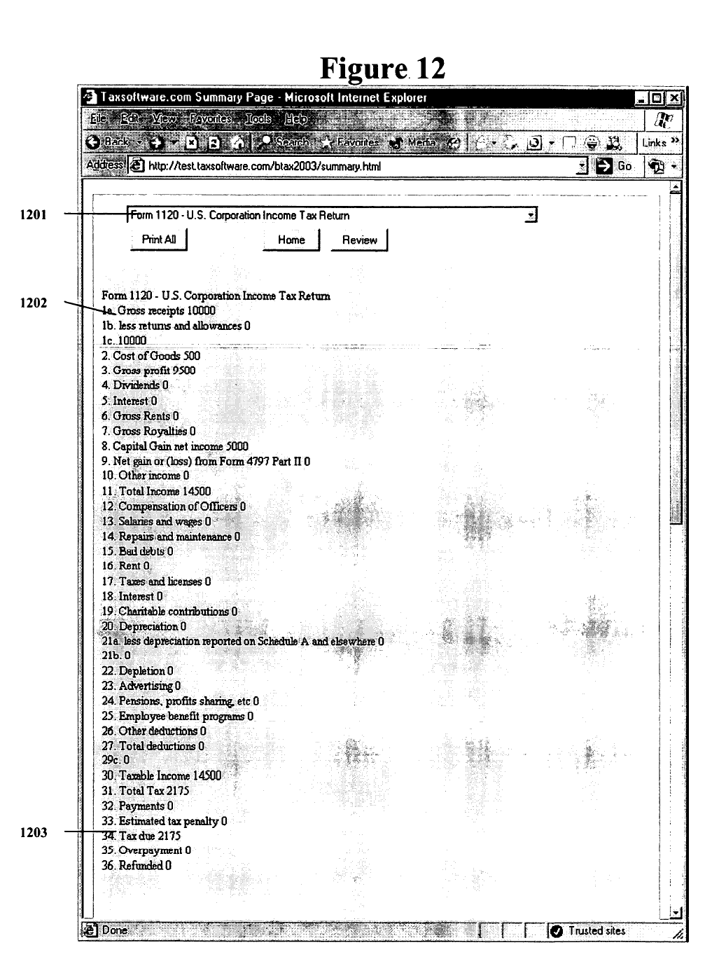

If the user selects the SUMMARY web page (FIG. 12) all of the taxes for the corporation are shown. The user selects the form from the top of the web page (1201). Then the calculations done for the form selected is shown (1202). The tax due to the IRS from the corporation is shown (1203).

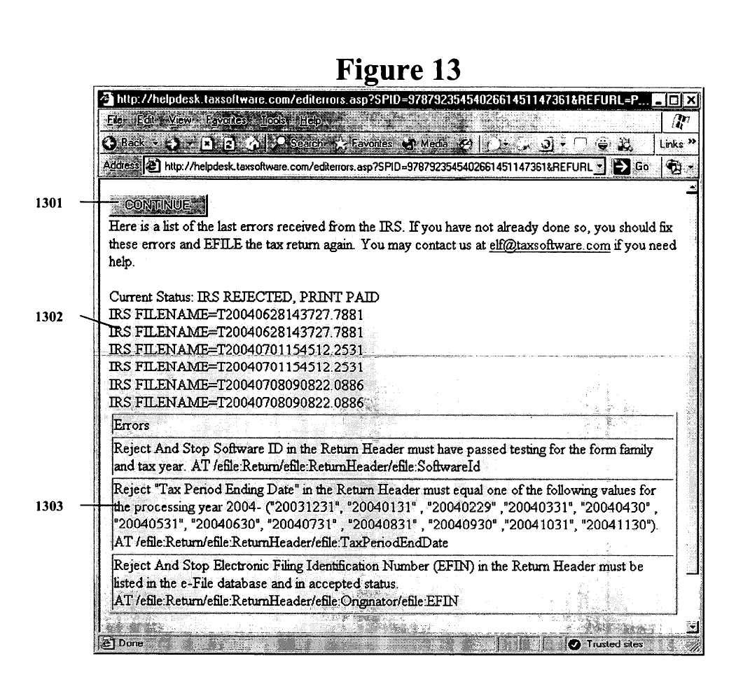

After a tax return is E-Filed an acknowledgement message is sent back to the user. If the tax return has no errors and is ACCEPTED by the IRS a message is displayed on the web site (FIG. 1). If there are errors the errors are shown in FIG. 13. The user can see the tracking number for each message (1302). Also, the user can see the message from the IRS (1303).

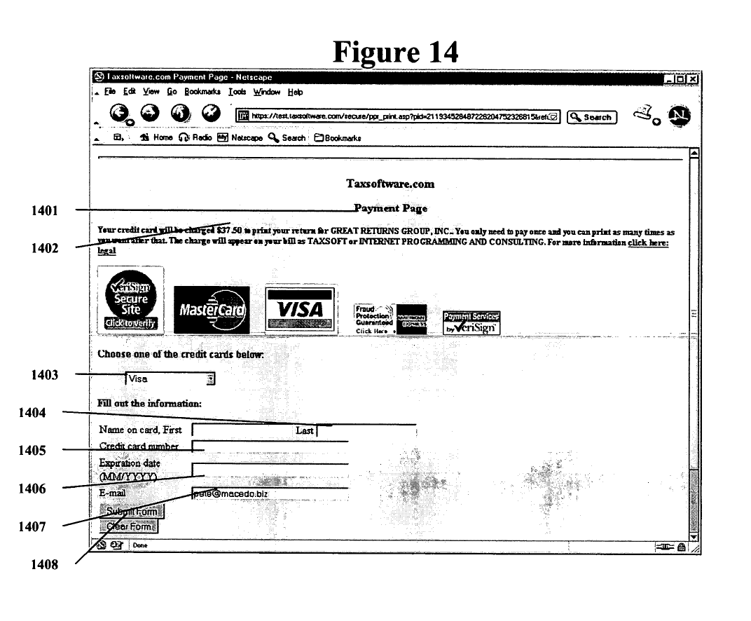

The website can provide a payment system so that the user can pay for each tax return prepared one at a time (FIG. 14). Here the user goes to the payment page (1401) when the user tries to print or E-File the tax return. The amount (1402) for one tax return is shown to the user. The user selects the credit card (1403), enter his or her name (1404), the credit card number (1405), the expiration date (1406) and email address (1407). Finally, the user clicks on submit to pay for the tax return (1408).

The user can also pay for multiple tax returns at the same time in a package price. The web page shows the current balance of paid for but unused business tax returns (1502). Then the user enters the number of individual tax return (1503) and business tax returns (1504) to purchase. The price for the new purchase is calculated (1504). The user then selects the payment method (1506) and enters the payment information including card holder name (1507), credit card or account number to charge (1508), Expiration date of credit card (1509), and email address of card holder (1510). After the information is entered the user can click on Update Price button (1512) to change the number of tax returns to be pre-paid. The Update Profile button can be used to change the profile information for the user. If all of the information is correct the user can click on PAY (1511) to charge the credit card or account. Any previous payments are shown in 1514 with the amount, the date of the charge, the amount of business and individual tax returns purchased. Any recent charges for tax returns are shown with the current status of the tax return and the date the charge was deducted from the account (1515).

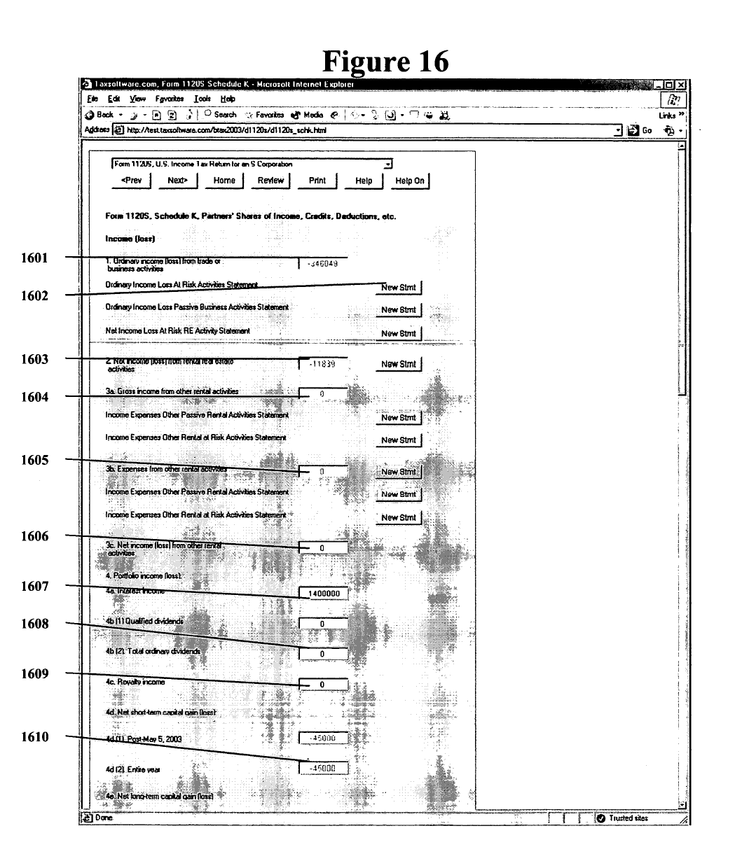

In FIG. 16 the user enters the Form 1120S Schedule K total income and expenses to distribute the shareholders via the Schedule K-1. The web sites calculates the ordinary income (loss) from trade or business activities (1601), the net income (loss) from rental real estate activities (1603), gross income for other rental activities (1604), expenses from other rental activities (1605). If the user needs to attach a detailed listing for any numbers on the web page the New Stmt button can be clicked (1062) to enter the itemized statement information. The user can then enter the net income (loss) from other rental activities (1606), portfolio interest income (1607), portfolio dividends (1608), and portfolio royalty income (1609). The web site can then calculate the net capital gains (1610). As per before if the user wants to change the results for any calculations the user can click on the input box and enter the correct override number for the input and a blue border shows up to show a calculation has been blocked (1610).

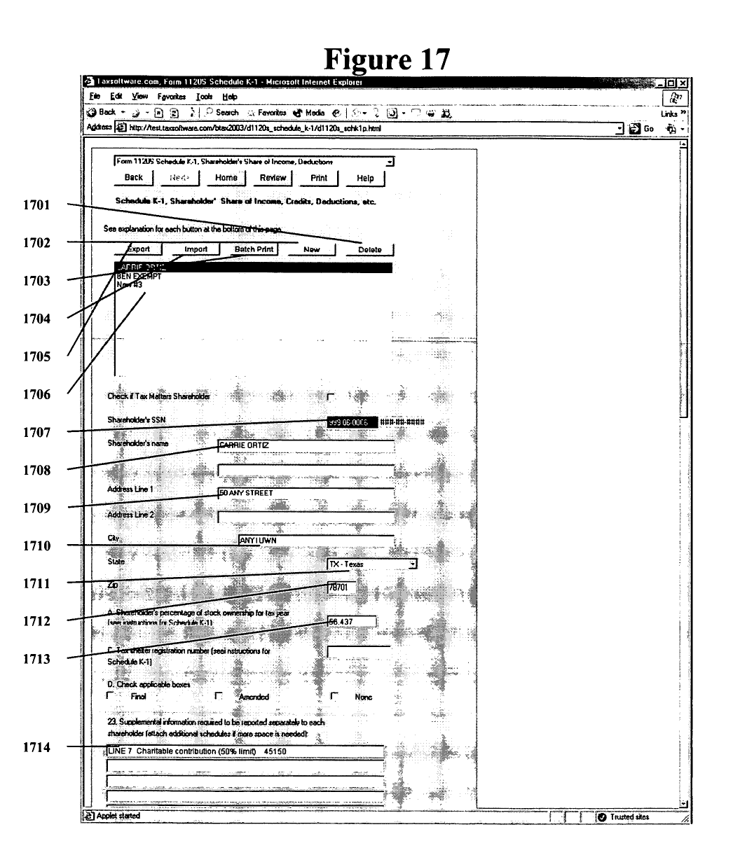

In FIG. 17 the information for each shareholder is entered to generate the K-1 for each shareholder. All of the shareholders previously entered show up in 1706. If the user wants to add a new shareholder the NEW button (1702) is clicked. To remove a shareholder the user can click on the shareholder listed in 1706 and click on the DELETE (1701) button. For the currently selected shareholder in 1706 the shareholder information is displayed in boxes 1707-1714. The user can enter the shareholder's SSN (1707), Shareholder's name (1708), shareholder's street address (1709), Shareholder's city (1710), Shareholder's state (1711), Shareholder's zip code 1711, shareholder's percentage of stock ownership for the year (1712), and any supplemental notes required to be sent to each shareholder (1714). The web site users the shareholder's percentage of stock ownership (1713) to distribute the K-1 income and expenses from FIG. 16 to each shareholder's K-1. The print the results of the distributions the user can click on the BATCH PRINT button (1703). Then each K-1 is printed for the user to send to the shareholder's.

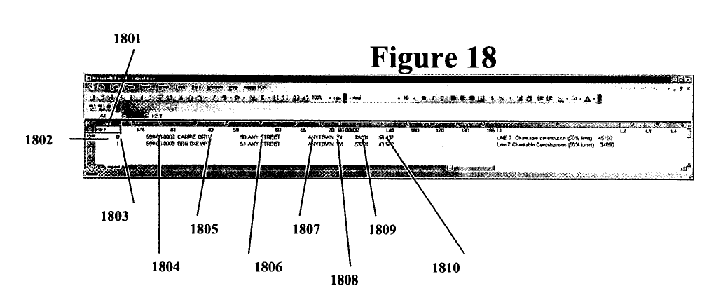

When the user clicks on the EXPORT button (1705) in FIG. 17 the spreadsheet show in FIG. 18 is generated. Each shareholder's information is put into a separate row of the spreadsheet (1802). The rows are numbered with a unique KEY (1801). All of the information from the FIG. 17 web page is entered into the spreadsheet into separate columns the shareholder's SSN (1804), the shareholder's name (1805), the shareholder's street address (1806), the shareholder's city (1807), the shareholder's state (1808), the shareholders zip code (1809), and the shareholder's percentage of ownership (1810). The user can then edit the spread sheet generated by the web site and paste data from the user's own computer in the spread sheet. After all the new shareholders are added to spreadsheet or edited in the spreadsheet the user can then IMPORT the data back to the web site by clicking on the IMPORT button (1704).

The entire disclosure of an American patent application Ser. No. 10/856,759, filed on Jun. 1, 2004 including specification, claims drawings and summary, on which the present application is based, are incorporated herein by reference in its entirety.

We claim:

1. A Corporate Business Income tax web site where a user enters the tax information into a web site using a web browser; the web site calculates the tax due; the corporate tax data is transferred to the taxing agency; an acknowledgment is received back from the taxing agency; the information in the acknowledgment is sent to the user.

2. The system of claim 1 where the acknowledgment includes either acceptance or rejection of the tax return.

3. The system of claim 2 where the acknowledgment includes error messages with the rejection of the tax return.

4. The system of claim 1 where the acknowledgment is sent the taxpayer via email.

5. The system of claim 1 where the user receives the acknowledgement by logging into a web site.

6. The system of claim 1 where the tax information is stored in a database.

7. The system of claim 1 where the tax information is stored in a flat file.

8. The system of claim 1 where the tax information is stored in a TAXDBC peer-to-peer database.

9. The system of claim 1 where the user enters balance sheet information into the web site.

10. The system of claim 9 where the user can enter Assets including cash, trade notes and account receivables, inventories, U.S. government obligations, other current assets, loans to shareholders, mortgage and real estate loans, other investments, buildings and other depreciable assets, land, other assets and total assets.

11. The system of claim 9 where the user can enter Liabilities and Shareholders' Equity including Accounts payable, Mortgages, notes, bonds payable in less then 1 year, other current liabilities, loans from shareholders, mortgages, notes, bonds payable in 1 year or more, other liabilities, capital stock, preferred stock, common stock, additional paid-in capital, retained earnings appropriated, retained earnings unappropriated, adjustments to shareholder's equity, treasury stock and total liabilities and shareholders' equity.

12. The system of claim 1 where the user enters income information into the web site.

13. The system of claim 12 where the user enters income information that can include gross receipts or sales, cost of goods sold, gross profit, dividends, interest, gross rents, gross royalties, capital gain net income, other income and total income.

14. The system of claim 1 where the user enters deduction information into the web site.

15. The system of claim 14 where the user enters deductions including compensation of officers, salaries and wages, repairs and maintenance, bad debts, rents, taxes and licenses, interest, charitable contributions, depreciation, depletion, advertising, pension, profit-sharing, employee benefit programs, other deductions and total deductions.

16. The system of claim 1 where the user also enters tax information for each subsidiary of the corporation and parent tax return and all of the subsidiary tax returns are transmitted to the IRS with the parent tax return.

17. The system of claim 1 where the web site sends web pages to the browser using HTML.

18. The system of claim 1 where the web site sends mobile code to the web browser.

19. The system of claim 18 where the web site uses JAVA.

20. The system of claim 18 where the web site uses JAVASCRIPT.

21. The system of claim 18 where the web site uses Microsoft .NET.

22. The system of claim 18 where the web site uses Active-X controls.

23. The system of claim 17 where Java Server Pages is used to generate the web pages to send to the browser.

24. The system of claim 17 where J2EE is used to generate the web pages to send to the browser.

25. The system of claim 17 where ASP is used to generate the web pages to send to the browser.

26. The system of claim 17 where Microsoft NET is used to generate the web pages to send to the browser.

27. The system of claim 17 where CGI is used to generate the web pages to send to the browser.

28. The system of claim 1 where tax payment information is sent to the taxing agency.

29. The system of claim 28 where the tax payment information includes a bank account number, routing transit number, payment date and payment amount.

30. The system of claim 1 where tax refund information is sent to the taxing agency.

31. The system of claim 30 where the tax refund information includes the account number and routing transit number of the bank account to receive the refund for the taxpayer.

32. The system of claim 1 where the tax payment information includes a credit card account number, expiration date of the credit card, amount and payment date.

33. The system of claim 1 where the user can import accounting information from a Tax Exchange Format file.

34. The system of claim 1 where the user can export information to a spread sheet.

35. The system of claim 1 where the user can import information from a spread sheet.

36. The system of claim 1 where the corporate income tax return can be either a IRS Form 1120 or IRS Form 1120S.

37. The system of claim 1 where the user can pay for the tax returns one at a time.

38. The system of claim 1 where the user can pay for the tax returns in groups.

39. The system of claim 1 where an error message is displayed on the web page if the user makes an error entering the tax return information.

40. The system of claim 1 where the user answers the questions in an interview in order to have the web site fill in the forms.

41. The system of claim 1 where the user can get a list of web pages in the tax return.

42. The system of claim 1 where the user can navigate randomly around the web site as needed.

43. The system of claim 41 where the user can click on any web page in the list and go directly to that web page skipping the other web pages in the tax return.

44. The system of claim 1 where the user can see a summary of tax information.

45. The system of claim 1 where the user can enter information about each shareholder and distribution information for each shareholder.

46. The system of claim 45 where the information about each shareholder can include name, address, and shareholder's percentage of stock ownership.

47. The system of claim 46 where the web site calculates all K-1 distributions for each shareholder.

48. The system of claim 47 where the K-1 distributions can include Ordinary income (loss) from trade or business, Net income (loss) from rental real estate activities, Net income (loss) from other rental activities, portfolio income (loss), interest income, dividends, royalty income, capital gain (loss), long-term capital gain (loss), short-term capital gain (loss), Other portfolio income (loss), Net section 1231 gain (loss), other income (loss), Charitable contributions, Section 179 expense deduction, deductions related to portfolio income (loss) and Other deductions.

49. The system of claim 1 where the user can override a calculation to manually force a number into a particular line on a tax form.

50. The system of claim 1 where the user can print the tax return from the web site.

51. A Corporate Business Income tax web site where a user enters the tax information into a web site using a web browser; the web site send mobile code to the user; the mobile code calculates the tax due; the corporate tax data is transferred to the taxing agency; an acknowledgment is received back from the taxing agency; the information in the acknowledgment is sent to the user.

52. A web site where the user who E-Files the tax return is verified using the digital ID.

53. The system of claim 52 where the user can purchase multiple tax returns to be E-Filed; where the payment is made from a pre-paid account and the user is identified by a digital certificate ID.
